(19) United States
(12) Patent Application Publication
(10) Pub. No.: US 2003/0032407 A1
(43) Pub. Date: Feb. 13, 2003

(54) System and method for preventing unauthorized use of a wireless or wired remote device

(76) Inventor: Ken Mages, Highland Park, IL (US)

Correspondence Address: Max Shaftal, PATZIK, FRANK & SAMOTNY, LTD., Suite 900, 150 South Wacker Drive, Chicago, IL, 60606, US

(21) Appl. No.: 10/215,078

(22) Filed: Aug. 8, 2002

Related U.S. Application Data
(60) Provisional application No. 60/311,189, filed on Aug. 8, 2001.

(51) Int. Cl. H04K 1/00; H04M 1/66; H04M 1/68; H04M 3/16

(52) U.S. Cl. 455/411; 380/247

(57) ABSTRACT

A system and method for determining whether an authorized user has retained possession of a device for participating in gaming activities. The system includes a wireless or wired remote device that is fitted with a kill switch that will disable use of the device until the authorized user resubmits the necessary verification. The kill switch may be activated by the lack of movement of the device, thermal sensors, capacity sensors, contact switches, dead-man switches or the like.

This application claims priority based upon U.S. Provisional Patent Application Serial No. 60/311,189 filed Aug. 8, 2001.

### FIELD OF THE INVENTION

This invention relates in general to gaming activities, and more particularly to a system and method for providing security for wireless or wired remote gaming activities, and still more particularly to a system and method for providing security for wireless or wired remote gaming activities that includes a kill switch to prevent the unauthorized use of the wireless device if left unattended or taken from the authorized user.

### BACKGROUND OF THE INVENTION

Casinos provide a venue for people to participate in gaming activities. Recently, there has been a push for casinos to provide services to enable their patrons to remotely participate in gaming activities. Therefore, instead of having to physically sit down at a table or machine, the patron may participate in gaming activities from other locations such as in a shopping mall or on a golf course.

In addition to verifying the correct time and location of a user on the casino property to ensure that the activity is legally transacted, it is also imperative that the use of the device be limited to the authorized user to prevent unauthorized gaming activities from taking place.

Heretofore, it has been known to use passwords in connection with a wireless device to restrict access to on-line transactions to individuals with knowledge of the requisite password. Other devices have included means for recording, storing and verifying biometric information of the user so that access will be denied if the biometric information of the individual seeking access does not match the stored biometric information of the user.

While biometric, password-protected or other conventional security devices can perhaps prevent an unauthorized user from powering on a wireless device and initially gaining access to on-line transactions through the wireless device, they may not prevent on-line transactions by unauthorized users. In particular, the known security devices do not protect against an unauthorized user using the wireless device——if the wireless device is put down or set aside after the authorized user activates the device. For example, if the authorized user leaves the unit powered on and inadvertently leaves it unattended while in the middle of an on-line gaming session, an unauthorized user may carry on a number of substantial losing wagers, which would be automatically charged to the authorized user.

If the authorized user challenges any losses on the basis that he or she did not authorize the wagers that led to the subsequent losses, then the casino would be put in the uncomfortable position of choosing between: (1) enforcing such losses and offending a potentially profitable guest, who may instead frequent a different casino or hotel in the future; or (2) absorbing the financial loss by not enforcing such losses.

It has also been known to have the device shut off after the failure to detect gaming activity for a predetermined amount of time. However, problems have arisen during the use of such security measures because of the pre-determined amount of time before shut-down. For instance, if a smaller time limit such as one minute is set for the device to shut off due to a lack of gaming activity, the device may shut off before the user has had the opportunity to complete the transaction. Conversely, if the interval before the device powers off is set at a large time limit, an unauthorized user may acquire an inadvertently unattended device and run up huge gaming losses during that interval. The losses would then be charged to the registered or authorized user as opposed to the actual user.

Therefore, there is a need to produce a wireless or wired remote device that protects against unauthorized use without interfering or interrupting the authorized use of the device.

### SUMMARY OF THE INVENTION

The present invention is an improvement over the prior security systems used to prohibit unauthorized use of a wireless or wired remote device for gaming activities. In particular, the security system of the present invention includes a wireless or wired remote device that may be connected to the Internet, casino server or the like to participate in gaming activities. The device includes an internal or external kill switch that automatically disables the device when the authorized user sets the device down to prevent any unauthorized uses of the device. One embodiment of a kill switch is an internal motion switch that includes a positively-charged central thin foil sheet having a free end located between the arms of a negatively-charged U-shaped member. Movement of the device causes the free end of the foil sheet to contact the arms of the U-shaped member to complete the circuit and allow for the device to continue to be used. If the completion of the circuit is not detected within a set amount of time, the wireless or wired remote device is disabled until proper authorization is verified.

It is therefore an object of the present invention to provide a new and improved security device for a wireless or wired remote device that prevents unauthorized transactions.

A further object of the present invention is to provide a security system for a wireless or wired remote device that does not interfere or interrupt the authorized use and enjoyment of the device.

Another object of the present invention is to provide a kill switch for a wireless or wired remote device that will automatically shut down an unattended device after a certain interval of inactivity, movement or contact.

A still further object of the present invention is to provide a security system for a wireless or wired remote device that is easy and economical to manufacture.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

FIG. 1 is a block diagram illustrating a device operably connected to the Internet to provide gaming activities and a plurality of transmitters which in turn are operably connected to a CDMA server within a building and a GPS base station and associated GPS antenna outside the building.

FIG. 2 is a schematic view of an embodiment of a wireless device of the present invention.

FIG. 3 is a vertical plan view of an embodiment of a wireless device of the present invention.

FIG. 4 is a vertical plan view of the back side of a wireless device showing a biometric thumb print scanner.

FIG. 5 is a simplified vertical plan view of an embodiment of a motion switch of the present invention.

FIG. 6 is a perspective view of a wireless device having a pressure sensitive band around its periphery.

FIG. 7 is a simplified flow chart illustrating the steps involved in ensuring that a wireless transaction is authorized.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

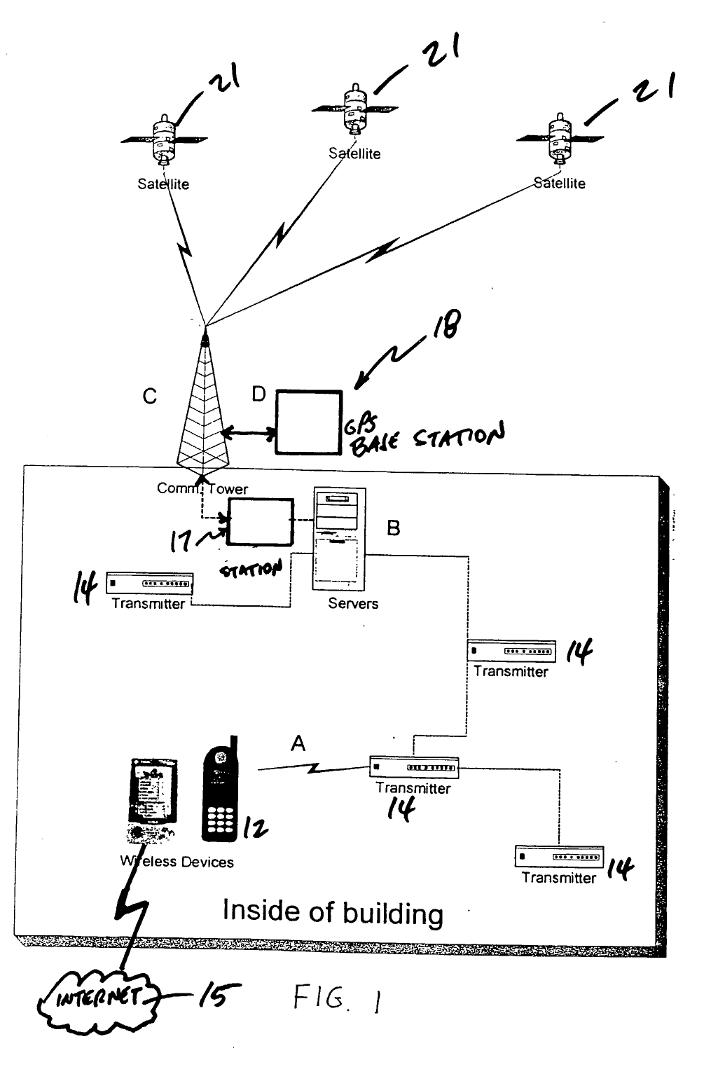

Referring now to the drawings, and particularly to FIG. 1, there is shown an example of an assisted global positioning system (hereinafter “AGPS”) that may be used with the present invention to provide wireless or wired gaming activities. The AGPS, generally designated by the number 10, is shown as having a device 12 operably connected to a plurality of transmitters 14 located throughout the inside of a building 16 to accurately determine the location of the device 12. Information collected from the device may then be transmitted to a microbase transceiver station 17, which in turn transmits the information to a GPS base station 18 having GPS base station circuitry and a GPS antenna 20 for transmitting and/or receiving the information or other transmissions to or from one of a plurality of GPS satellites 21 orbiting the earth. While GPS is referred to herein as the method for locating the user, other location methods or triangulation-based technology should be considered as being capable of being used with the present invention. The device is connected to the Internet 15 or a server associated with a casino to enable the device to offer gaming activities. While the transmitters are shown as being located within the interior of a building, it is appreciated that they also may be located outside the building as well, so as to assist in determining the location of the device outside. It is also appreciated that the transmitters may transmit the information directly to the device, which in turn transmits the information to the GPS base station.

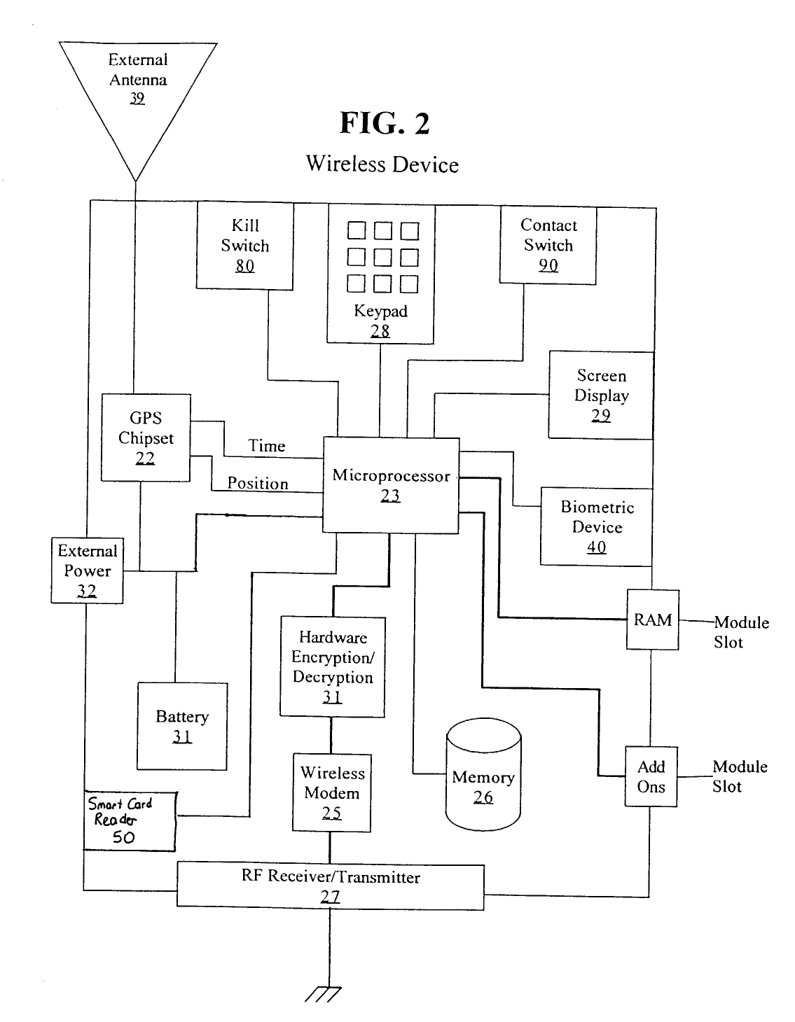

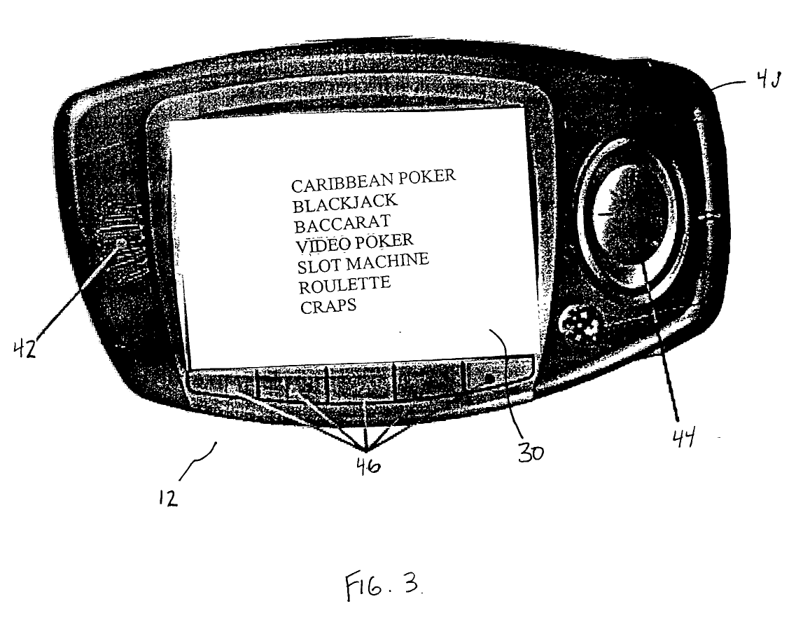

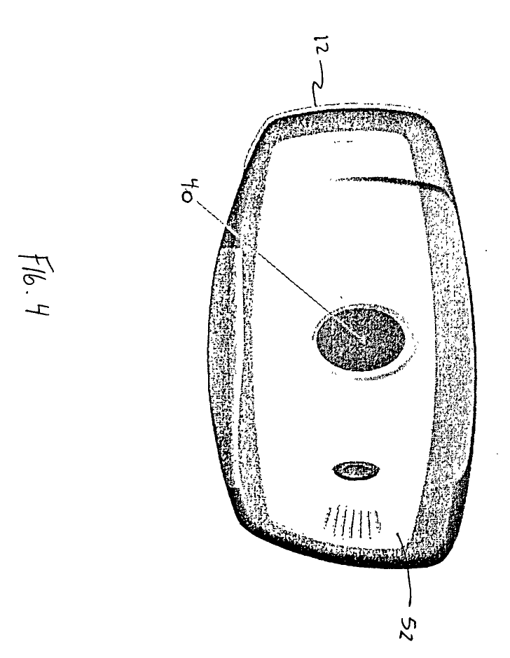

Referring now to FIGS. 2 and 3, a wireless device for use in the present invention is shown. As shown in FIG. 2, the wireless device 12 may include a GPS chipset 22 for providing time and geographic position data to a microprocessor 23, means for providing hardware encryption and decryption of all information sent or received 24 from the wireless device 12, and a wireless modem 25 or other means for connecting to the Internet 15, remote server or the like. The wireless device 12 is also provided with memory 26, a RF or IR receiver/transmitter 27, a keypad 28 for manually inputting data and a display screen 30.

Alternatively, the display screen 30 can be a touch screen that serves as both the keypad for inputting information and the display screen. The keypad 28 can also be a peripheral device such as an external keyboard or a series of buttons 46 and a multi-directional thumb pad 44. Likewise, hardware encryption/decryption can be provided by the GPS chipset 22. Also provided are an external GPS antenna 39 and a receiver/transmitter antenna 38. The GPS chipset 22, kill switch 80, keypad 28, contact switch 90, screen display 30, biometric device 40, ram module slot 95, memory 26, external power 32 and battery 31 and RF receiver/transmitter are all connected to the microprocessor 23. It also is appreciated that the wireless or wired remote device may include any other components known in the art to allow a wireless or wired remote device to send, retrieve and display information to participate in wireless gaming activities.

The example of the wireless device 12 shown and disclosed is sized so that it may be readily transported throughout the casino building 16. A smart or swipe card reader 50 having a unique identification number is preferably used in conjunction with the wireless device to allow the wireless device to be selectively activated and used on different occasions. For example, the smart card may be inserted into a smart card reader 50 on the side of the wireless device in a known way to allow the wireless device to access the information on the smart card to verify and determine identity and account information. Once a smart card is issued and inserted into the wireless device 12, the wireless device communicates with the Internet 15 to allow for secure, legal wagers to be placed from within the casino or on the casino grounds. While a modular wireless device is shown, it is appreciated that the device may be a cellular phone, a wireless device having cellular phone capabilities, other wireless devices such as PDAs and the like, or a wired gaming device. Similarly, while a device for participating in gaming activities is shown and disclosed, it is appreciated that the device may be used for any secure transactions, such as on-line shopping, financial transactions or the like.

As shown in FIG. 2, the wireless device 12 includes the viewing or display screen 30, such as an LCD screen, for displaying information; one or more speakers 42 for providing voice or sound in conjunction with the selections or results; and a multi-directional thumb pad 44 and a series of button 46 on the face 48 of the wireless device 12 for selecting and playing the various gaming activities or games associated with the wireless device.

The kill switch 80 of the wireless device may be any kind of switch that is capable of detecting when the wireless device has been set aside, placed down or otherwise left unattended. One such embodiment of a kill switch is one or more conventional internal or external motion switches 80 of the type generally known in the prior art for opening or closing a circuit upon a predetermined degree of movement being applied thereto. Referring to FIG. 5, one such motion switch would have a positively-charged central thin, foil sheet 82 having a free end 84 surrounded by a pair of arms 88 of a negatively-charged U-shaped member 86. In operation, virtually any slight movement of the device 12 would cause the free end 84 of the foil sheet 82 to make momentary contact with either of the oppositely charged arms 88 of the U-shaped member 86 located on either side of the foil sheet 82, thereby closing a circuit and sending a signal to the microprocessor 23. The device can be programmed so that if no such motion is detected within a predetermined amount of time, on-line usage is terminated and a new thumbprint or other verification means from the authorized user would be needed before the device would resume on-line usage. While a U-shaped member with a foil sheet is shown, it is appreciated that other types of motion sensors, such as the Tilt-Actuated Switch of U.S. Pat. No. 5,153,394, should be considered as being within the scope of this invention.

It is also appreciated that multiple contact switches of the type generally known in the prior art can also be provided on the top and bottom of the device for opening or closing a circuit when pressure is applied to the contact switch, such as by placing the wireless device down on a surface. While one contact switch may be employed, it is preferred that multiple contact switches be used, for example, near the comers of the top and bottom of the device. Such switches may be spring-biased outwardly so that when the device is placed down on a surface, such as a table, one or more of the switches would close, thereby opening or breaking a circuit to discontinue the gaming activities or otherwise sending a signal to the microprocessor that the device has been placed down by the user. The switches are sensitive enough to be activated if placed down on a couch, chair or carpeted floor. Once placed down, use of the wireless device to participate in gaming activities would be suspended and the entry of another verified thumbprint would be needed before use could be resumed.

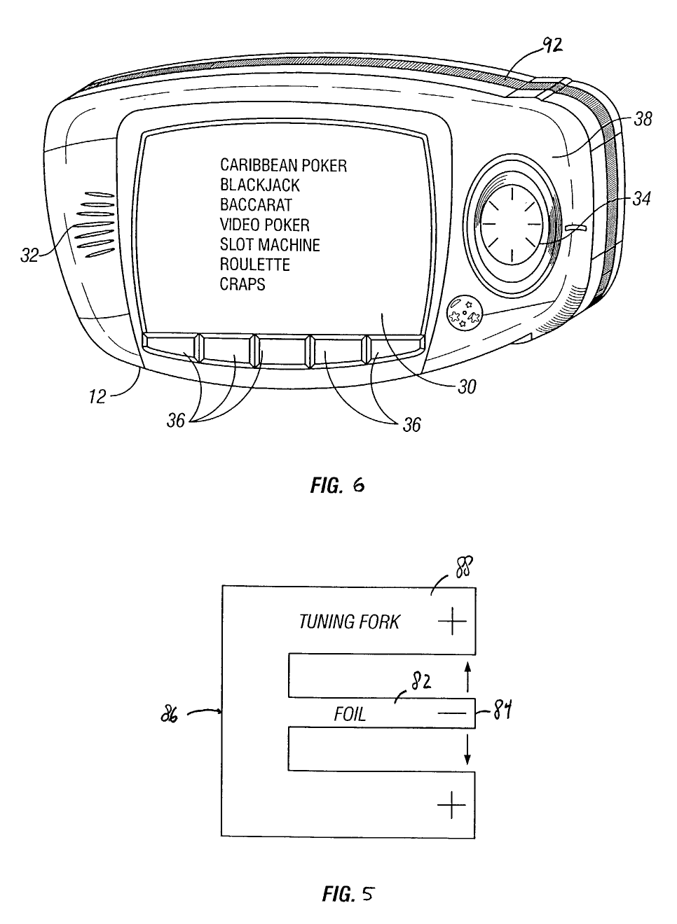

Alternatively, the device could include a conventional “dead man's switch” of the type generally known in the prior art, wherein in order to maintain continued on-line access, the user would have to continuously activate a switch located on the outside of the device in order to keep the circuit closed. For example, as shown in FIG. 6, the wireless device may include a pressure-sensitive band 92 that surrounds the outer circumference of the wireless device 12, where the wireless device 12 would normally be held. Holding the device pushes the pressure sensitive band against the wireless device to close the circuit and supply power to the wireless device. Upon release of the dead man's switch (e.g., the device is placed on a table or the like), the circuit is opened and the wireless device would terminate the on-line connection. The switch is preferably spring-loaded and biased into the open position, so that the removal of the pressure from the pressure sensitive band results in opening of the circuit. Release of the wireless device for any purpose would thereby suspend use and require the entry of another verified thumbprint or some other form of identification verification before use is resumed.

Other types of kill switches may include, but are not limited to, thermal sensor switches and capacitor sensors that allow continued use of the device so long as thermal or electrical sensors detect human activity within a preset range. The foregoing kill switch features could be similarly applied to a wired device, such as one that has a wired power, Internet or network connection. Additionally, the foregoing kill switch features can also be applicable to those devices that do not have GPS or other location identification capabilities.

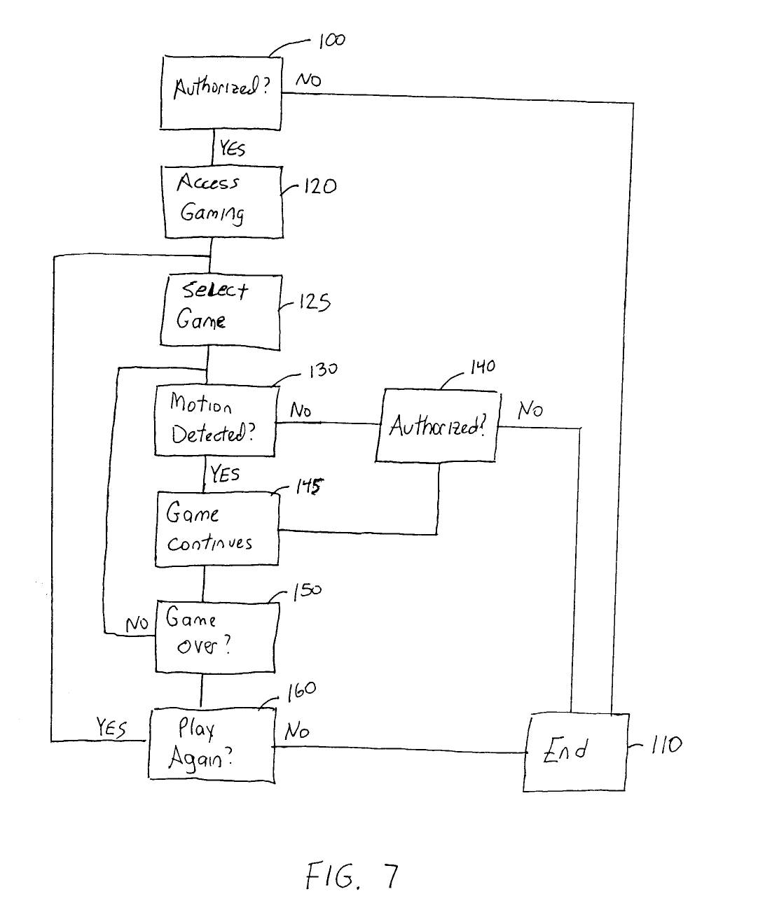

As indicated in the simplified flow diagram of FIG. 7, the device 12, when started will request verification of an authorized use in step 100. Verification of an authorized use of the wireless device may be accomplished through the use of a biometric device 40 such as a thumbprint or retinal scanner, or any other known means. Examples of a thumbprint scanner are U-Match Biolink® or ThumbTrax® devices embedded in the exterior of the device. Alternatively, biometric device 40 can be an external peripheral device such as a mouse or Compact Flash Card. If the proper verification is not inputted or received, then the wireless device will not permit access to the gaming activities and the use of the wireless device will end in step 1 10 until proper verification is submitted. On the other hand, if verification in the form of the proper thumbprint or otherwise is inputted and confirmed, then the wireless device (12) is connected to the Internet (15), casino server or the like to permit the authorized gaming activities to commence in step 120. Once the gaming activities commence, a particular game may be selected in step 125.

If during use of the wireless device, the motion sensor kill switch 80 fails to sense motion for a predetermined amount of time in step 130, use of the wireless device will be suspended by the microprocessor 23 in step 1 10 unless verification of an authorized use is completed in step 140. If the verification step is completed, gaming activities may again be engaged in through the use of the wireless device. Likewise, if during use of the wireless device, the dead man's switch detects that the wireless device is no longer being held or has been placed down on a couch or table, then use of the wireless device to participate in gaming activities will be suspended unless and until identity verification is provided. If the proper identification information is not inputted into the wireless device, then the gaming activities will end in step 110.

Alternatively, if the motion sensor kill switch detects motion within the preset amount of time in step 130, the wireless device will allow for the gaming activities to continue in step 145. The motion sensor kill switch will continue to monitor whether the wireless device moves within the prescribed time period until the particular gaming activity is completed in step 150. Thus, if the motion sensor kill switch fails to detect motion before the transaction is completed, then the wireless device will disconnect the wireless device from the Internet, network or casino server in step 110 until proper authorization is once again inputted in step 100 or step 140.

Upon completion of the gaming activity in step 150, the wireless device will display a message in step 160 inquiring whether it is desired to play another game. If another game is desired, the game may be selected and played in step 125. Otherwise, the wireless device may shut down if no further gaming activities are desired in step 110.

It will be understood that modifications and variations may be effected without departing from the scope of the novel concepts of the present invention, but it is understood that this application is limited only by the scope of the appended claims.

1. A system for preventing the unauthorized use of a device comprising:
a device for performing one or more transactions;
means to detect when the device is left unattended; and
means to prevent performance of the transactions when it is determined that the device has been left unattended.

2. A system for preventing unauthorized remote gaming activities comprising:
a device for allowing an authorized user to participate in gaming activities;
means to provide gaming activities;
means to detect when the device is left unattended; and
means to cease the gaming activities when it is determined that the device has been left unattended.

3. The system of claim 2 wherein the device is a wireless device.

4. The system of claim 3 wherein the detection means comprises a motion sensor.

5. The system of claim 4 wherein the motion sensor comprises a positively-charged thin foil strip located between a pair of arms of a negatively-charged U-shaped member, wherein movement of the wireless device causes the thin foil strip to contact one of the arms the U-shaped member to complete a circuit.

6. The system of claim 5 wherein the means to cease gaming activities comprises means to determine if the circuit is completed within a predetermined amount of time.

7. The system of claim 3 wherein the detecting means comprises a dead man's switch.

8. The system of claim 7 wherein the dead man's switch comprises a pressure-sensitive band located around the wireless device.

9. The system of claim 3 wherein the detecting means comprises a contact switch.

10. The system of claim 3 wherein the detecting means comprises a thermal sensor.

11. The system of claim 3 wherein the detecting means comprises a capacitor sensor.

12. The system of claim 3 which further comprises means to verify identity of the authorized user.

13. The system of claim 12 wherein the identifying means comprises a biometric scanning device.

14. The system of claim 13 wherein the identifying means comprises a password.

15. A method for preventing the unauthorized use of a device comprising the steps of:
providing a device to an authorized user for performing one or more transactions;
providing means to activate the device;
detecting whether the authorized user has retained possession of the device; and
selectively allowing the performance of the transactions depending on whether the authorized user has retained possession of the device.

16. A method for preventing unauthorized remote gaming activities comprising the steps of:
providing a device to an authorized user for performing gaming activities;
providing means to activate the device;
detecting whether the authorized user has retained possession of the device;
selectively allowing the gaming activities to proceed depending on whether the authorized user has retained possession of the device.

17. The method of claim 16 wherein the device is a wireless device.

18. The method of claim 17 wherein the step of detecting whether the authorized user has retained possession of the wireless device comprises means to determine whether the wireless device has been moved within a predetermined time period.

19. The method of claim 18 wherein the step of detecting whether the authorized user has retained possession of the wireless device comprises using a motion sensor.

20. The method of claim 19 wherein the motion sensor comprises a positively-charged thin foil strip located between a pair of arms of a negatively-charged U-shaped member, wherein movement of the wireless device causes the thin foil strip to contact one of the arms of the U-shaped member to complete a circuit.

21. The method of claim 20 wherein the step of detecting whether the authorized user has retained possession of the wireless device further comprises means to determine if the circuit is completed within a predetermined amount of time.

22. The method of claim 17 wherein the step of detecting whether the authorized user has retained possession of the wireless device comprises using a dead man's switch.

23. The method of claim 22 wherein the contact switch comprises a pressure-sensitive band located around the wireless device.

24. The method of claim 17 wherein the step of detecting whether the authorized user has retained possession of the wireless device comprises using a contact switch.

25. The method of claim 17 wherein the step of detecting whether the authorized user has retained possession of the wireless device comprises using a thermal sensor.

26. The method of claim 17 wherein the step of detecting whether the authorized user has retained possession of the wireless device comprises using a capacity sensor.

27. The method of claim 17 wherein the step of detecting whether the authorized user has retained possession of the wireless device comprises means to determine whether the wireless device has been placed on a surface.

28. The method of claim 17 which further comprises the step of verifying the authorized use of the wireless device after the wireless device is shut down.

29. The method of claim 28 wherein the step of verifying the authorized use comprises using a biometric scanner.

30. The method of claim 28 wherein the step of verifying the authorized user comprises inputting a password.
